(19) United States
(12) Patent Application Publication
(10) Pub. No.: US 2025/0045830 A1
(43) Pub. Date: Feb. 6, 2025

(54) ADAPTABLE DATA RECORD FOR CONDITIONAL USE DATA RESOURCES

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST, West Chester, PA (US); Hitesh BAJAJ, Duluth, GA (US); Kenneth Tien Poh WONG, Oakville (CA)

(73) Assignee: The Toronto-Dominion Bank, Toronto, ON (CA)

(21) Appl. No.: 18/364,073

(22) Filed: Aug. 2, 2023

(51) Int. Cl. G06Q 40/06

(52) U.S. Cl. CPC G06Q 40/06

(57) ABSTRACT

Systems and methods for managing conditional use data resources are described. A conditional data record is disclosed. The conditional data record records only data resources having conditions restricting use and excludes data resources defined in a non-conditional data record. A first transfer of first data resources is received to an account. The first transfer has a first condition restricting use of the first data resources. The conditional data record is updated based on the first data resources. A transfer request for second data resources is received. The transfer request includes metadata defining a second condition. Based on the metadata, a determination is made regarding whether data resources associated with the conditional data record or data resources associated with the non-conditional data record should be used to complete the transfer request. The transfer request is completed.

### TECHNICAL FIELD

The present application relates to data records and, more particularly, to systems and methods for managing conditional use data resources.

### BACKGROUND

While data resources may be transferred freely between a transferor and a transferee, there are instances when data resources may be provided for a specific use. For example, certain data may be of a confidential nature, and a transferor may wish to restrict further transfers of the data to a set of specific transferees and/or to associate a specific time period in connection with access to the transferred data.

At present, a transferor typically has no means of ensuring that a transferee abides by requested data transfer conditions. Similarly, having agreed to data transfer conditions, a transferee typically has no means of easily monitoring conditions associated with received data resources.

Similarly, a transferee may have no means of easily tracking conditions associated with received data resources.

Improvements to the field are desired.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level operation diagram of an example computing device;

FIG. 3 depicts a simplified organization of software components stored in the memory of the example computer device;

FIG. 4 is an example screen display of a client device;

FIG. 5 is a first flow chart showing operations performed by a system, in accordance with an embodiment of the present disclosure;

FIG. 6 is a second flow chart showing operations performed by a system, in accordance with an embodiment of the present disclosure;

FIG. 7 is a third flow chart showing operations performed by a system, in accordance with an embodiment of the present disclosure;

FIG. 8 is a fourth flow chart showing operations performed by a system, in accordance with an embodiment of the present disclosure;

FIG. 9 shows a first user interface, in accordance with an embodiment of the present disclosure; and

FIG. 10 shows a first user interface, in accordance with an embodiment of the present disclosure.

Like reference numerals are used in the drawings to denote like elements and features.

### DETAILED DESCRIPTION OF VARIOUS EMBODIMENTS

In accordance with one aspect of the present disclosure, there is provided a system comprising a communications module, a processor coupled to the communications module, and a memory coupled to the processor. The memory stores instructions which, when executed, configure the processor to receive a first transfer of first data resources to an account, the first transfer having a first condition restricting use of the first data resources; update a conditional data record based on the first data resources, the conditional data record recording only data resources associated with conditions restricting use, the conditional data record excluding data resources defined in a non-conditional data record that records data resources having no conditions restricting use; receive a transfer request for second data resources, the transfer request including metadata defining a second condition; based on the metadata, determine whether data resources associated with the conditional data record or data resources associated with the non-conditional data record should be used to complete the transfer request; and complete the transfer request.

In some implementations, the system is further configured to, prior to completing the transfer request, determine whether data resources associated with the non-conditional data record are sufficient to complete the transfer request. The transfer request is completed in response to determining that the data resources associated with the non-conditional data record are sufficient to complete the transfer request without first evaluating the conditional data record.

In some implementations, the processor is further configured to, after completing the transfer request: determine that the conditional data record records data resources associated with the second condition; in response to determining that the conditional data record records data resources associated with the second condition; update the conditional data record to decrease, by a certain quantity, the data resources recorded as associated with the second condition; and update the non-conditional data record to decrease, by a difference between the second data resources and the certain quantity, the data resources recorded by the non-conditional data record. The certain quantity is a lesser of the second data resources and the data resources associated with the second condition.

In some implementations, the processor is further configured to, prior to completing the transfer request: determine that the conditional data record records third data resources associated with the second condition, the third data resources being insufficient to complete the transfer request; determine that the non-conditional data record records fourth data resources; and determine that a sum of the third data resources and the fourth data resources is sufficient to complete the transfer request. The transfer request is completed in response to determining that the sum of the third data resources and the fourth data resources is sufficient to complete the transfer request.

In some implementations, the processor is further configured to, after completing the transfer request: update the conditional data record to reduce, to zero, the recorded data resources associated with the second condition; and update the non-conditional data record to reduce the recorded data resources by a difference between the second data resources and the third data resources.

In some implementations the processor is further configured to, prior to completing the transfer request, determine that the data resources associated with the second condition recorded by the conditional data record are sufficient to complete the transfer request. The transfer request is completed in response to determining that the data resources associated with the second condition recorded by the conditional data record are sufficient to complete the transfer request.

In some implementations, the first and second conditions are related to one or more of a transfer category, a set of specific transferees, or a time period.

In some implementations the first condition is related to a time period, and the processor is further configured to: determine that an amount of time between a time of the first transfer and a current time exceeds the time period; and send a second transfer of the first data resources to a transferor of the first transfer.

In some implementations, the processor is further configured to: generate a user interface that displays a metric combining the conditional data record and the non-conditional data record.

In some implementations, the processor is further configured to: generate a user interface that displays one or more metrics, each of the one or more displayed metrics reflecting data resources associated with a distinct condition recorded by the conditional data record.

In some implementations, the metadata included in the transfer request is defined by a transferor of the transfer request.

In some implementations, the data resources recorded by the conditional data record and the data resources recorded by the non-conditional data record are fungible data resources.

In some implementations, prior to receiving the first transfer of first data resources to an account, the processor is further configured to: send, to a transferor of the first transfer, confirmation of acceptance of the first condition restricting use of the first data resources.

In accordance with another aspect of the present disclosure, there is provided a method comprising: receiving a first transfer of first data resources to an account, the first transfer having a first condition restricting use of the first data resources; updating a conditional data record based on the first data resources, the conditional data record recording only data resources associated with conditions restricting use, the conditional data record excluding data resources defined in a non-conditional data record that records data resources having no conditions restricting use; receiving a transfer request for second data resources, the transfer request including metadata defining a second condition; based on the metadata, determining whether data resources associated with the conditional data record or data resources associated with the non-conditional data record should be used to complete the transfer request; and completing the transfer request.

In some implementations, prior to completing the transfer request, the method further comprises determining whether data resources associated with the non-conditional data record are sufficient to complete the transfer request. The transfer request is completed in response to determining that the data resources associated with the non-conditional data record are sufficient to complete the transfer request without first evaluating the conditional data record.

In some implementations, after completing the transfer request, the method further comprises determining that the conditional data record records data resources associated with the second condition; in response to determining that the conditional data record records data resources associated with the second condition; updating the conditional data record to decrease, by a certain quantity, the data resources recorded as associated with the second condition; and updating the non-conditional data record to decrease, by a difference between the second data resources and the certain quantity, the data resources recorded by the non-conditional data record. The certain quantity is a lesser of the second data resources and the data resources associated with the second condition.

In some implementations, the method further comprises, prior to completing the transfer request: determining that the conditional data record records third data resources associated with the second condition, the third data resources being insufficient to complete the transfer request; determining that the non-conditional data record records fourth data resources; and determining that a sum of the third data resources and the fourth data resources is sufficient to complete the transfer request. The transfer request is completed in response to determining that the sum of the third data resources and the fourth data resources is sufficient to complete the transfer request.

In some implementations the method further comprises, after completing the transfer request: updating the conditional data record to reduce, to zero, the recorded data resources associated with the second condition; and updating the non-conditional data record to reduce the recorded data resources by a difference between the second data resources and the third data resources.

In some implementations, the method further comprises, prior to completing the transfer request: determining that the data resources associated with the second condition recorded by the conditional data record are sufficient to complete the transfer request. The transfer request is completed in response to determining that the data resources associated with the second condition recorded by the conditional data record are sufficient to complete the transfer request.

In accordance with yet another aspect of the present disclosure, there is provided a non-transitory computer-readable storage medium comprising processor-executable instructions which, when executed, configure a processor to: receive a first transfer of first data resources to an account, the first transfer having a first condition restricting use of the first data resources; update a conditional data record based on the first data resources, the conditional data record recording only data resources associated with conditions restricting use, the conditional data record excluding data resources defined in a non-conditional data record that records data resources having no conditions restricting use; receive a transfer request for second data resources, the transfer request including metadata defining a second condition; based on the metadata, determine whether data resources associated with the conditional data record or data resources associated with the non-conditional data record should be used to complete the transfer request; and complete the transfer request.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

A system may operate an adaptable or programmatic data record for the recording of data resources associated with conditions (i.e., “conditional data resources”). The system may operate the adaptable or programmatic record together with a standard data record for the recording of data resources unencumbered by conditions (i.e., “non-conditional data resources”). The system may allow a user to view metrics delineating categories of conditions associated with data records.

A transferor may define conditions in connection with data resources to be transferred, in order to restrict use of the data resources by the transferee. In some embodiments, acceptance of the data resources by the transferee may be predicated on the acceptance of the conditions. In some embodiments, different categories of conditions may be defined. For example, categories corresponding to a particular future recipient or set of future recipients, and/or categories related to time periods may be defined.

In some embodiments, conditions may be enforced by metadata included in a transfer request. The system may approve or deny a transfer request based on one or more categories associated with requested data resources.

The system may efficiently implement the management of data resources such that data transfers are not slowed by the association of conditions with data resources. For example, in at least some implementations, when a transfer request is received, the system may not immediately evaluate whether conditional data resources are available for the particular transfer request. Instead, the system may simply approve the transfer after determining that there are sufficient non-conditional data resources available to complete the transfer, without first evaluating the available conditional data resources. In such implementations, since conditional data resources are only evaluated prior to transfer approval when insufficient non-conditional funds are available, the speed of data transferring is not hampered by the presence of conditional data resources.

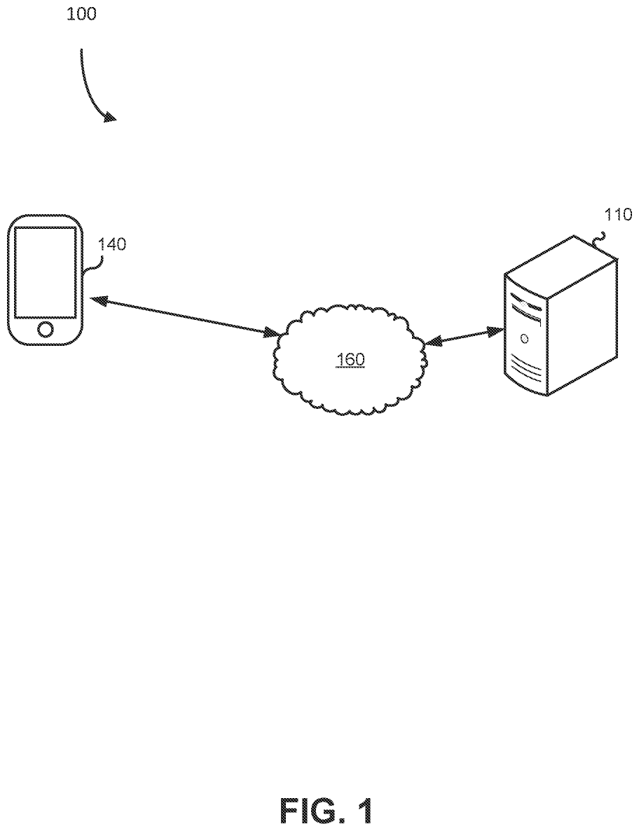

FIG. 1 is a schematic operation diagram illustrating an operating environment of an example embodiment.

As illustrated, the operating environment 100 includes a database management system 110 and a client device 140 in communication via a network 160.

Each of the database management system 110 and the client device 140 may be in geographically disparate locations. Put differently, one or more of the database management system 110 and the client device 140 may be remote to others of the database management system 110 and the client device 140.

The database management system 110 and the client device 140 are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The database management system 110 may be a single server, multiple servers, a server farm, or any other such arrangement of computing devices to implement computing server-like functionality. In some embodiments, the database management system 110 may track, manage, and maintain owned data resources belonging to respective entities. The data resources may be represented in a database. The secure storage(s) may be provided internally within the database management system 110 or externally. The secure storage(s) may, for example, be provided remotely from the database management system 110. For example, the secure storage(s) may include one or more data centers. The data centers may, for example, store data with bank-grade security.

The data resources may, for example, be computer code, spreadsheet data, and/or database information and may include image, text, audio and/or video files. Additionally or alternatively, the data resources may be computing resources, such as memory or processor cycles. Additionally or alternatively, the data resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The data resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

In some embodiments, the database management system 110 may include records for a plurality of data resource accounts and at least some of the records may define a quantity of data resources. A first entity may be associated with one or more accounts storing or otherwise reflecting data resources, i.e., a data resource account. Such data resources may include owned resources. The data resources stored or reflected by the one or more accounts may be associated with one or more conditions (i.e., “conditional data resources”), or may be associated with no conditions (i.e., “non-conditional data resources”). The records may define metrics reflecting a total quantity of data resources that are associated with the first entity. The records may further define metrics reflecting one or more quantities of conditional data resources and/or a quantity of non-conditional data resources that are associated with the first entity. The metrics may be or may include one or more balances; for example, one or more bank balances.

In some embodiments, the database management system 110 may, for example, be a computing client, such as a web client, an email client, an online chat client, and/or a video game client. In some embodiments, the database management system 110 may, for example, be an associated financial institution server and the first entity may be a customer of the respective financial institution operating the associated financial institution server.

While FIG. 1 illustrates a single database management system 110, more than one such database management system may be engaged and connected through the network 160. For example, data resources may be transferred between resource accounts stored at different database management systems, wherein each database management system is associated with a particular provider or institution. The data resources may be transferred from a first resource account stored at a database management system associated with a first provider or institution to a second resource account stored at a second database management system associated with a second provider or institution.

The client device 140 is also a computing device. In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be associated with an entity, such as a user or client, having resources associated with the database management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

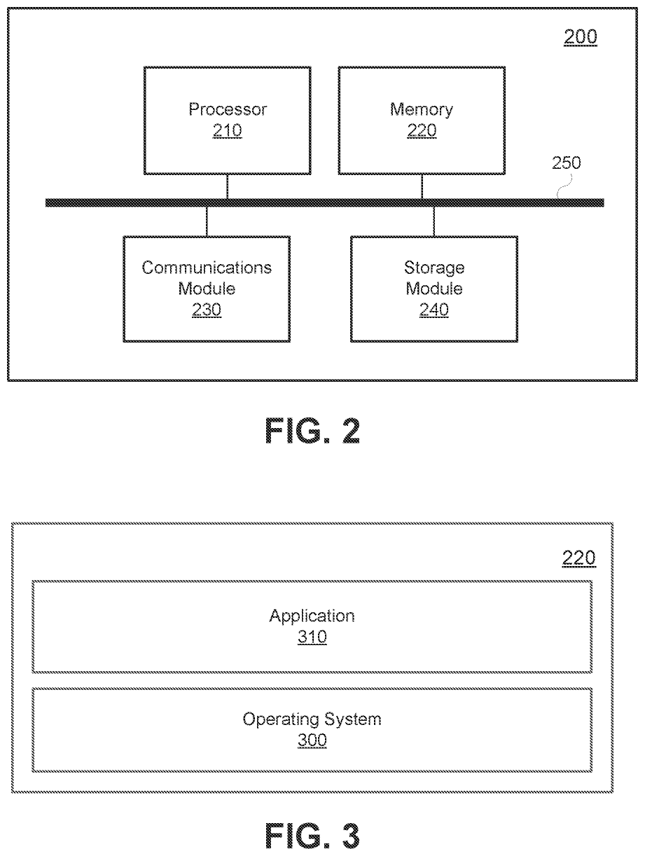

Referring now to FIG. 2, a high-level operation diagram of an example computing device 200 will now be described. The example computing device 200 may be exemplary of the database management system 110 and/or the client device 140.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 will include other components apart from those illustrated in FIG. 2 and the specific component set may differ based on whether the example computing device 200 is operating as the database management system, the client device, the second database management system, and/or the third database management system. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Linux™, Microsoft™, Windows™. Apple™, Apple OSX™, Android™ or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the database management system and/or the client device.

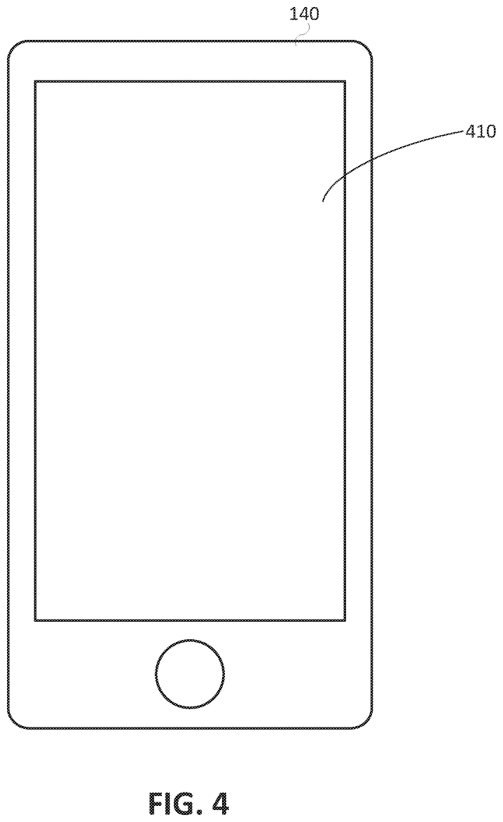

FIG. 4 shows the front of the client device 140 of FIG. 1. The client device 140 may be a personal computing device, such as a smart phone, as shown in FIG. 4. As previously described, the client device 140 may be a computing device of another type such as a laptop computer, a desktop computer, a tablet computer, a notebook computer, a hand-held computer, a personal digital assistant, a portable navigation device, a mobile phone, a wearable computing device.

As illustrated, the front of the client device 140 includes a display 410. The display 410 is a module of the smart phone embodiment of the client device 140. The display 410 is for presenting graphics. The display 410 may be, for example, a liquid crystal display (LCD). In addition to being an output device, the display 410 may also be an input device. For example, the display 410 may allow touch input to be provided to the client device 140. In other words, the display 410 may be a touch sensitive display module. In a particular example, the display 410 may be a capacitive touch screen.

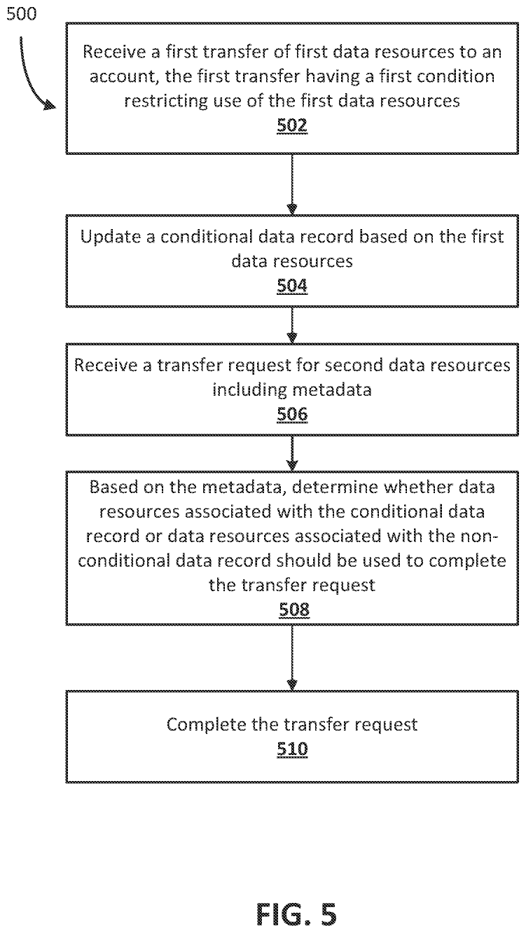

The operation of the database management system 110 (FIG. 1) will now be described with reference to the flowchart of FIG. 5 which illustrates a method 500 for completing a transfer request. In performing the method 500, operations starting from the operation 502 and continuing onward are performed by a processor of the database management system 110 (FIG. 1). For example, where the database management system 110 (FIG. 1) is or includes an instance of the example computing device 200 (FIG. 2), the operations may be performed by the processor 210 (FIG. 2) executing instructions, such as, for example, from the memory 220 (FIG. 2). Those instructions may, for example, be part of a suitable instance of the application software 310 (FIG. 3).

At the operation 502, the database management system receives a first transfer of first data resources to an account, the first transfer having a first condition restricting use of the first data resources. The first condition may, for example, be defined by metadata associated with the first transfer. The metadata may be defined by a transferor of the transfer request. The first condition may be related to, for example, one or more of a set of specific transferees, a time period, or a transfer category. In some implementations, the set of specific transferees may be a particular entity and/or individual. In some implementations, the set of specific transferees may be a set of specific transferees having a particular level of security clearance. In some implementations, the time period may relate to a defined period of time within which the data resources must be consumed in order to avoid an automatic return to the original transferor. In some implementations where the data resources represent stored value, the transfer category may be associated with one or more merchant categories (e.g., education, grocery, vehicle, etc.) and/or with one or more particular merchants. In some implementations, more than one condition may be associated with a data transfer. In some implementations, prior to receiving the first transfer of first data resources to an account, the system may send, to the transferor of the first transfer, confirmation of acceptance of the first condition restricting use of the first data resources.

At the operation 504, the system updates a conditional data record based on the first data resources. The conditional data record may record only data resources associated with conditions restricting use.

The conditional data record may associate conditions with data resources in connection with the account. For example, if the first data resources is a first spreadsheet, and the first transfer of the first spreadsheet has a first condition restricting use to recipients having security clearance A, the conditional data transfer record may record the first spreadsheet as being associated with security clearance A.

The data resources may be fungible data resources. As a further example, if the first data resources is a first stored value, and the first transfer of the first stored value has a first condition restricting use to recipients associated with tuition, the conditional data record may record the first stored value as being associated with tuition.

The conditional data record may exclude data resources defined in a non-conditional data record. The non-conditional data record may record data resources having no conditions restricting use.

At the operation 506, the system receives a transfer request for second data resources, the transfer request including metadata. In some implementations, the transfer request may include metadata comprising fields identifying a category, such as, for example, when the transfer request is ISO 20022 compliant. In some implementations, the metadata may identify a security clearance. As a further example, the metadata may identify categories such as tuition or groceries.

At the operation 508, the system determines, based on the metadata, whether data resources associated with the conditional data record or data resources associated with the non-conditional data record should be used to complete the transfer request. In some embodiments, the system may evaluate whether a transfer request should be approved or denied based on the metadata included in the transfer request. For example, the transfer request may request the first spreadsheet having a condition restricting use to recipients having a security clearance A. However, the metadata included in the transfer request may define a security clearance B in connection with the requestor. As a result, the system may deny the transfer request. As a further example, in some implementations, the transfer request may request a certain quantity of stored value having a condition restricting use to recipients associated with tuition, and the metadata included in the transfer request may define vehicle as the category associated with the requestor. As a result, the system may deny the transfer request.

In this way, in some examples, the system may determine, based on the conditions associated with quantities of stored value recorded in the conditional data record, that the transfer request should be denied.

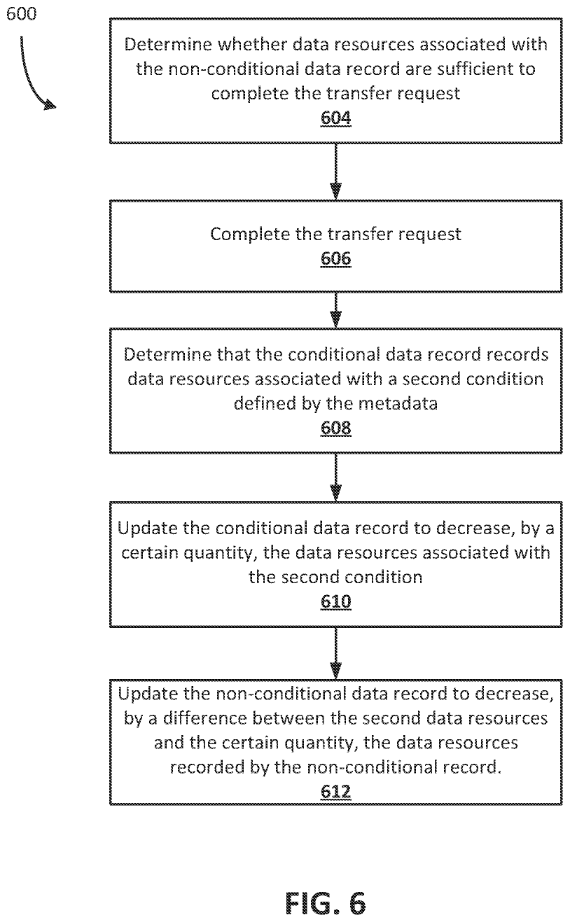

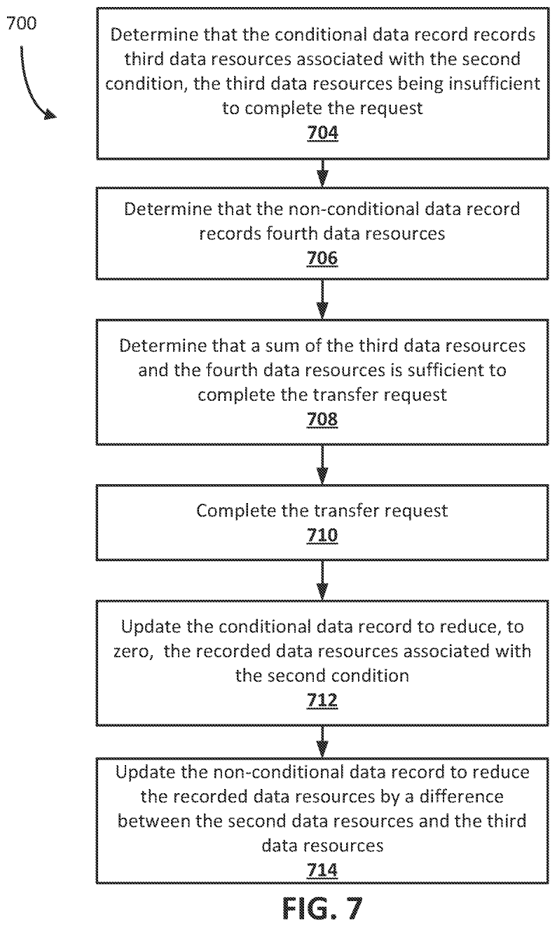

The determination of which data resources should be used to complete the transfer request may take various forms. Embodiments of the determination will be discussed in connection with FIGS. 6 and 7.

At the operation 510, the system completes the transfer request.

As noted, the determination based on the metadata, at the operation 508, of which data resources should be used to complete the transfer request may take various forms. In some embodiments, the determination may be made in accordance with the method 600 of FIG. 6.

Reference is now made to FIG. 6, which provides a flowchart illustrating a first method 600 in connection with determining, based on the metadata, whether data resources associated with the conditional data record or data resources associated with the non-conditional data record should be used to complete the transfer request, and with updating the conditional and/or non-conditional records accordingly. In performing the method 600, operations starting from the operation 604 and continuing onward are performed by a processor of the database management system 110 (FIG. 1). For example, where the database management system 110 (FIG. 1) is or includes an instance of the example computing device 200 (FIG. 2), the operations may be performed by the processor 210 (FIG. 2) executing instructions such as, for example, from the memory 220 (FIG. 2). Those instructions may, for example, be part of a suitable instance of the application software 310 (FIG. 3).

At the operation 604, the system determines, based on the metadata, whether data resources associated with the non-conditional data record are sufficient to complete the transfer request for the second data resources. For example, the requested second data resources may be a stored value, such as 500 units of data, and the metadata included in the transfer request may identify a second condition, a category of “Grocery”. The non-conditional data record may record 6100 units of data. In this example, the data resources associated with the non-conditional data record are sufficient to complete the transfer request for the second data resources (6100 units>500 units).

At the operation 606, the system completes the transfer request in response to determining that the data resources associated with the non-conditional data record are sufficient to complete the transfer request without first evaluating the conditional record.

At the operation 608, the system determines that the conditional data record records data resources associated with a second condition defined by the metadata. For example, the system may determine that a conditional data record records data resources associated with the second condition, the category of “Grocery.”

At the operation 610, the system updates the conditional data record to decrease, by a certain quantity, the record of data resources associated with the second condition. The certain quantity may be equal to the entirety of the recorded data resources associated with the second condition or may be equal to a portion of the recorded data resources associated with the second condition.

In some embodiments, the requested second data resources may exceed, or may be equal to, the recorded data resources associated with the second condition, and the certain quantity may be equal to the entirety of the recorded data resources associated with the second condition. In a first example, the requested second data resources may be 500 units of data, and the recorded data resources associated with the second condition may be 300 units of data. In the first example, the certain quantity may be equal to the recorded data resources associated with the second condition, i.e., to 300 units of data.

In some embodiments, the requested second data resources may be fewer than the recorded data resources associated with the second condition, and the certain quantity may be equal to a portion of the recorded data resources associated with the second condition. In a second example, the requested second data resources may be 200 units of data, and the recorded data resources associated with the second condition may be 300 units of data. In the second example, the certain quantity may be equal to a portion of the recorded data resources associated with the first condition, i.e., to 200 units of data.

At the operation 612, the system decreases, by a difference between the requested second data resources and the certain quantity, the data resources recorded by the non-conditional record.

Referring again to the first example described in connection with the operation 610, the requested second data resources are described as 500 units of data, and the certain quantity is described as 300 units of data. Under the conditions of the first example, the system, at the operation 612, may update the non-conditional data record to decrease the recorded data resources by 200 units, since the difference between the requested second data resources (500 units) and the certain quantity (300 units) is 200 units of data.

Referring again to the second example described in connection with the operation 610, the requested second data resources are described as 200 units of data and the certain quantity is described as 200 units of data. Under the conditions of the second example, the system may update the non-conditional data record to decrease the recorded data resources by zero units, since the difference between the requested second data resources (200 units) and the certain quantity (200 units) is zero units of data.

It will be noted that the combined decrease in the conditional data record and the non-conditional data record will be equal to the requested second data resources.

In this way, by determining whether data resources associated with the non-conditional data record are sufficient to complete a transfer request prior to evaluating whether data resources associated with the conditional data record are available for a transfer request, management of the conditional and/or non-conditional data records may be achieved without incurring a delay in the processing of transfer requests.

Reference is now made to FIG. 7, which provides a flowchart illustrating a second method 700 in connection with determining, based on the metadata, whether data resources associated with the conditional data record or data resources associated with the non-conditional data record should be used to complete the transfer request, and with updating the conditional and/or non-conditional records accordingly. In performing the method 700, operations starting from the operation 704 and continuing onward are performed by a processor of the database management system 110 (FIG. 1). For example, where the database management system 110 (FIG. 1) is or includes an instance of the example computing device 200 (FIG. 2), the operations may be performed by the processor 210 (FIG. 2) executing instructions such as, for example, from the memory 220 (FIG. 2). Those instructions may, for example, be part of a suitable instance of the application software 310 (FIG. 3).

At the operation 704, the system determines that the conditional data record records third data resources associated with the second condition, the third data resources being insufficient to complete the transfer request for the second data resources. The determination may be made, for example, subsequent to a determination of whether data resources associated with the non-conditional data record are sufficient to complete the transfer request. In a third example, the requested second data resources may be 15000 units of data, and the metadata included in the transfer request may identify a second condition, a category of “Tuition”. The conditional data record may record 14000 units of data associated with the second condition, the category of “Tuition.” In this example, the third data resources recorded by the conditional data record associated with the second condition are insufficient to complete the transfer request for the second data resources.

At the operation 706, the system determines that the non-conditional data record records fourth data resources.

At the operation 708, the system determines that a sum of the third data resources and the fourth data resources is sufficient to complete the transfer request. In the third example, the system may determine that the non-conditional data record records 6100 units of data, and that the sum of the third data resources (14000 units of data) and the fourth data resources (4100) is sufficient to complete the transfer request of 15000 units of resources (14000+4100>15000).

At the operation 710, the system completes the transfer request in response to determining that the sum of the third data resources and the fourth data resources is sufficient to complete the transfer request.

At the operation 712, the system updates the conditional data record to reduce, to zero, the recorded data resources associated with the second condition. Under the circumstances of the third example, the conditional data record may be updated to reduce, to zero, the recorded data resources associated with the category of “Tuition”.

At the operation 714, the system updates the non-conditional data record to reduce the recorded data resources by a difference between the second data resources and the third data resources. In the third example, the requested second data resources is 15000 units of data, and the third data resources is 14000 units of data. As a result, in the third example, the system may update the non-conditional data record to reduce the recorded data resources by 1000 units of data (15000−14000=1000).

It will again be noted that the combined decrease in the conditional data record and the non-conditional data record will be equal to the requested second data resources.

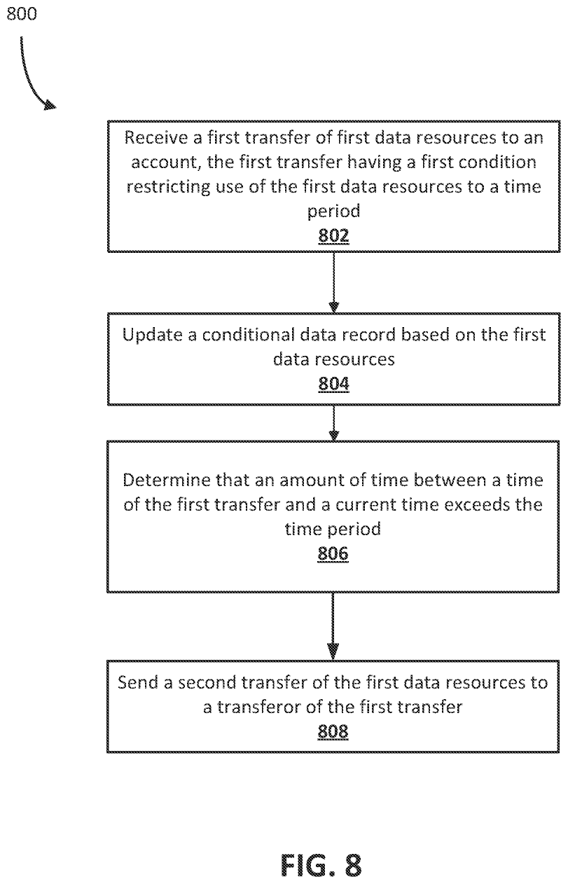

Reference is now made to FIG. 8, which provides a flowchart illustrating a method 800 in connection with sending a second transfer of the first data resources to a transferor of the first transfer. In performing the method 800, operations starting from the operation 802 and continuing onward are performed by a processor of the database management system 110 (FIG. 1). For example, where the database management system 110 (FIG. 1) is or includes an instance of the example computing device 200 (FIG. 2), the operations may be performed by the processor 210 (FIG. 2) executing instructions such as, for example, from the memory 220 (FIG. 2). Those instructions may, for example, be part of a suitable instance of the application software 310 (FIG. 3).

At the operation 802, the database management system receives a first transfer of first data resources to an account, the first transfer having a first condition restricting use of the first data resources to a time period. The first condition may, for example, be defined by metadata associated with the first transfer. The metadata may be defined by a transferor of the transfer request. The time period may relate to a defined period of time within which the data resources must be consumed in order to avoid an automatic return to the transferor. In some implementations, prior to receiving the first transfer of first data resources to an account, the system may send, to the transferor of the first transfer, confirmation of acceptance of the first condition restricting use of the first data resources.

At the operation 804, the system updates a conditional data record based on the first data resources.

As noted, the conditional data record may associate conditions, such as a time period, with data resources in connection with an account. For example, if the first data resources is a first spreadsheet, and the first transfer of the first spreadsheet has a first condition restricting use to a particular time period of 24 hours, the conditional data transfer record may record the first spreadsheet as being associated with a time period of 24 hours.

As a further example, if the first data resources is a first stored value, and the first transfer of the first stored value has a first condition restricting use to a time period of one month, the conditional data record may record the first stored value as being associated with the time period of one month.

At the operation 806, the system determines that an amount of time between a time of the of the first transfer and a current time exceeds the time period. For example, the time of the first transfer may be recorded as 12:00 AM on Jan. 1, 2024, and the time period may be recorded as 24 hours. At 12:00 AM on Jan. 2, 2024, the system may determine that the amount of time between a time of the of the first transfer and a current time exceeds the time period. As a further example, the time of the first transfer may be recorded as 12:00 AM on Jan. 1, 2024, and the time period may be recorded as one month. At 12:00 AM on Feb. 1, 2024, the system may determine that the amount of time between a time of the of the first transfer and a current time exceeds the time period.

At the operation 808, the system sends a second transfer of the first data resources to a transferor of the first transfer. In this way, the system may automatically return data resources to an original transferor when the transferred data resources are not used within a specified period of time.

As noted, in some embodiments, a user may be provided with means for viewing metrics delineating categories of conditions associated with data records.

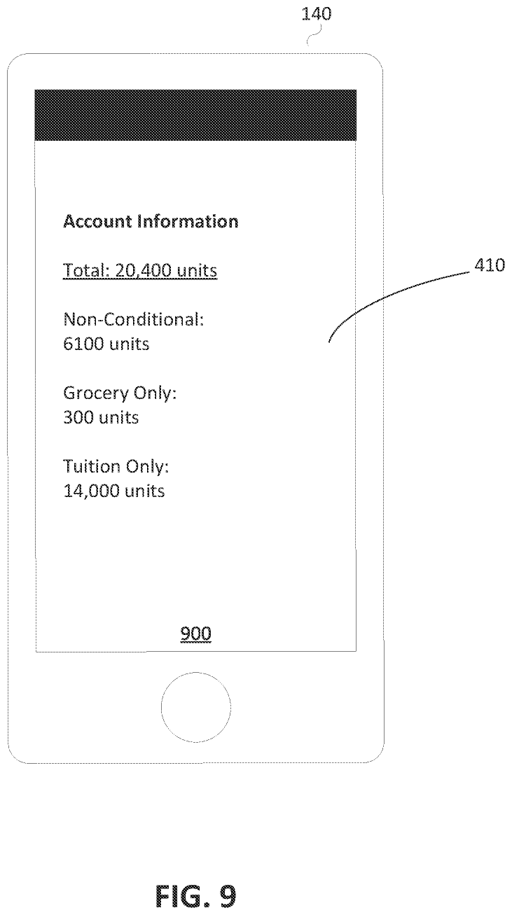

Reference is now made to FIG. 9, which shows a first example user interface 900 for use in displaying metrics delineating categories of conditions associated with data records. The first example user interface 900 includes a metric combining a conditional data record and a non-conditional data record, as well as one or more metrics reflecting data resources associated with a distinct condition recorded by the conditional data record.

As illustrated, the display 410 of the client device 140 displays the first example user interface 900.

The first example user interface 900 displays text corresponding to a conditional data record and a non-conditional data record associated with a data resource account. As shown, the first example user interface 900 is entitled “Account Information,” and indicates total data resources of 20,400 units. In the example of FIG. 9, 20,400 units is a metric that combines the conditional data record and the non-conditional data record associated with the account.

The first example user interface 900 also displays two quantities of conditional data resources associated with the conditional data record. As shown, the first quantity of conditional data resources relates to the category of “Grocery” and indicates a total data resources of 300 units. As further shown, the second quantity of conditional data resources relates to the category of “Tuition” and indicates a of total data resources of 14,000 units.

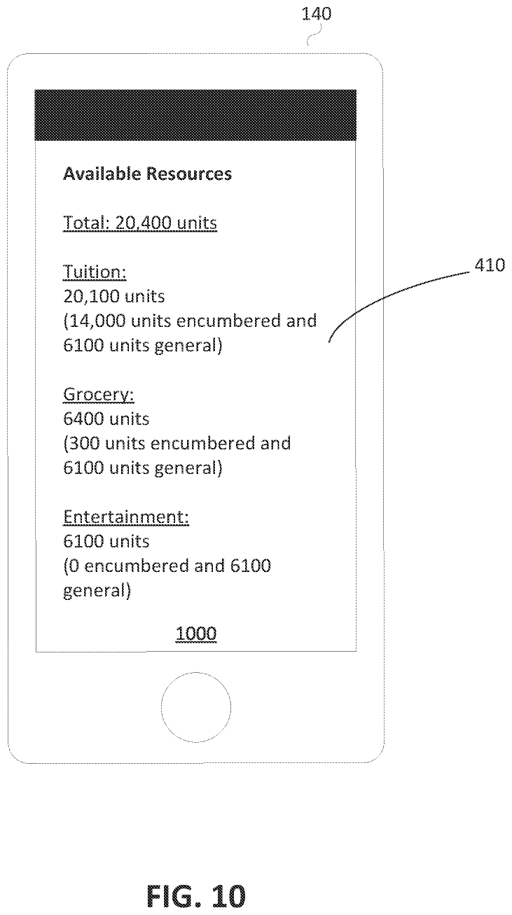

Reference is now made to FIG. 10, which shows a second example user interface 1000 for use in displaying metrics delineating categories of conditions associated with data records. The second example user interface 1000 includes a metric combining a conditional data record and a non-conditional data record, as well as one or more metrics reflecting data resources associated with a distinct condition recorded by the conditional data record.

As illustrated, the display 410 of the client device 140 displays the second example user interface 1000.

The second example user interface 1000 displays text corresponding to a conditional data record and a non-conditional data record associated with a data resource account. As shown, the second example user interface 1000 is entitled “Available Resources,” and indicates total data resources of 20,400 units. In the example of FIG. 10, 20,400 units is a metric that combines the conditional data record and the non-conditional data record associated with the account.

The second example user interface 1000 also displays three categories of conditions associated with the conditional data record. The displayed categories are “Tuition”, “Grocery” and “Entertainment”. Displayed below each of these categories is the total amount of data resources available to each category, including a delineation of the recording of the composition of these data resources.

As shown, in connection with the category “Tuition”, a total amount of data resources available to this category is displayed as 20,100 units. 14,100 units of this total are identified as being “encumbered” and 6100 units of this total are identified as being “general”. The identification of the 14,000 units as “encumbered” indicates that these 14,000 units are recorded by the conditional data record under the category of “Tuition”. The identification of the 6100 units as “general” indicates that these 6100 units are recorded by the non-conditional data record.

As further shown, in connection with the category “Grocery”, a total amount of data resources available to this category is displayed as 6400 units. 300 units of this total are identified as being “encumbered” and 6100 units of this total are identified as being “general”. The identification of the 300 units as “encumbered” indicates that these 300 units are recorded by the conditional data record under the category of “Grocery”. The identification of the 6100 units as “general” indicates that these 6100 units are recorded by the non-conditional data record.

As still further shown, in connection with the category “Entertainment”, a total amount of data resources available to this category is displayed as 6100 units. Zero units of this total are identified as being “encumbered” and 6100 units of this total are identified as being “general”. The identification of zero units as “encumbered” indicates that zero units are recorded by the conditional data record under the category of “Entertainment”. The identification of the 6100 units as “general” indicates that these 6100 units are recorded by the non-conditional data record.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A system comprising:
a communications module;
a processor coupled to the communications module;
a memory coupled to the processor, the memory storing instructions which, when executed, configure the processor to:
receive a first transfer of first data resources to an account, the first transfer having a first condition restricting use of the first data resources;
update a conditional data record based on the first data resources, the conditional data record recording only data resources associated with conditions restricting use, the conditional data record excluding data resources defined in a non-conditional data record that records data resources having no conditions restricting use;
receive a transfer request for second data resources, the transfer request including metadata defining a second condition;
based on the metadata, determine whether data resources associated with the conditional data record or data resources associated with the non-conditional data record should be used to complete the transfer request; and
complete the transfer request.

2. The system of claim 1, wherein the system is further configured to, prior to completing the transfer request:
determine whether data resources associated with the non-conditional data record are sufficient to complete the transfer request,
wherein the transfer request is completed in response to determining that the data resources associated with the non-conditional data record are sufficient to complete the transfer request without first evaluating the conditional data record.

3. The system of claim 2, wherein the processor is further configured to, after completing the transfer request:
determine that the conditional data record records data resources associated with the second condition;
in response to determining that the conditional data record records data resources associated with the second condition;
update the conditional data record to decrease, by a certain quantity, the data resources recorded as associated with the second condition; and
update the non-conditional data record to decrease, by a difference between the second data resources and the certain quantity, the data resources recorded by the non-conditional data record,
wherein the certain quantity is a lesser of the second data resources and the data resources associated with the second condition.

4. The system of claim 1, wherein the processor is further configured to, prior to completing the transfer request:
determine that the conditional data record records third data resources associated with the second condition, the third data resources being insufficient to complete the transfer request;
determine that the non-conditional data record records fourth data resources; and
determine that a sum of the third data resources and the fourth data resources is sufficient to complete the transfer request,
wherein the transfer request is completed in response to determining that the sum of the third data resources and the fourth data resources is sufficient to complete the transfer request.

5. The system of claim 4, wherein the processor is further configured to, after completing the transfer request:
update the conditional data record to reduce, to zero, the recorded data resources associated with the second condition; and
update the non-conditional data record to reduce the recorded data resources by a difference between the second data resources and the third data resources.

6. The system of claim 1, wherein the processor is further configured to, prior to completing the transfer request,
determine that the data resources associated with the second condition recorded by the conditional data record are sufficient to complete the transfer request,
wherein the transfer request is completed in response to determining that the data resources associated with the second condition recorded by the conditional data record are sufficient to complete the transfer request.

7. The system of claim 1, wherein the first and second conditions are related to one or more of a transfer category, a set of specific transferees, or a time period.

8. The system of claim 1, wherein the first condition is related to a time period, and wherein the processor is further configured to:
determine that an amount of time between a time of the first transfer and a current time exceeds the time period; and
send a second transfer of the first data resources to a transferor of the first transfer.

9. The system of claim 1, wherein the processor is further configured to:
generate a user interface that displays a metric combining the conditional data record and the non-conditional data record.

10. The system of claim 1, wherein the processor is further configured to:
generate a user interface that displays one or more metrics, each of the one or more displayed metrics reflecting data resources associated with a distinct condition recorded by the conditional data record.

11. The system of claim 1, wherein the metadata included in the transfer request is defined by a transferor of the transfer request.

12. The system of claim 1, wherein the data resources recorded by the conditional data record and the data resources recorded by the non-conditional data record are fungible data resources.

13. The system of claim 1, wherein prior to receiving the first transfer of first data resources to an account, the processor is further configured to:
send, to a transferor of the first transfer, confirmation of acceptance of the first condition restricting use of the first data resources.

14. A method comprising:
receiving a first transfer of first data resources to an account, the first transfer having a first condition restricting use of the first data resources;
updating a conditional data record based on the first data resources, the conditional data record recording only data resources associated with conditions restricting use, the conditional data record excluding data resources defined in a non-conditional data record that records data resources having no conditions restricting use;
receiving a transfer request for second data resources, the transfer request including metadata defining a second condition;
based on the metadata, determining whether data resources associated with the conditional data record or data resources associated with the non-conditional data record should be used to complete the transfer request; and
completing the transfer request.

15. The method of claim 14, further comprising, prior to completing the transfer request:
determining whether data resources associated with the non-conditional data record are sufficient to complete the transfer request,
wherein the transfer request is completed in response to determining that the data resources associated with the non-conditional data record are sufficient to complete the transfer request without first evaluating the conditional data record.

16. The method of claim 15, further comprising, after completing the transfer request:
determining that the conditional data record records data resources associated with the second condition;
in response to determining that the conditional data record records data resources associated with the second condition;
updating the conditional data record to decrease, by a certain quantity, the data resources recorded as associated with the second condition; and
updating the non-conditional data record to decrease, by a difference between the second data resources and the certain quantity, the data resources recorded by the non-conditional data record,
wherein the certain quantity is a lesser of the second data resources and the data resources associated with the second condition.

17. The method of claim 14, further comprising, prior to completing the transfer request:
determining that the conditional data record records third data resources associated with the second condition, the third data resources being insufficient to complete the transfer request;
determining that the non-conditional data record records fourth data resources; and
determining that a sum of the third data resources and the fourth data resources is sufficient to complete the transfer request,
wherein the transfer request is completed in response to determining that the sum of the third data resources and the fourth data resources is sufficient to complete the transfer request.

18. The method of claim 17, further comprising, after completing the transfer request:
updating the conditional data record to reduce, to zero, the recorded data resources associated with the second condition; and
updating the non-conditional data record to reduce the recorded data resources by a difference between the second data resources and the third data resources.

19. The method of claim 14, further comprising, prior to completing the transfer request:
determining that the data resources associated with the second condition recorded by the conditional data record are sufficient to complete the transfer request,
wherein the transfer request is completed in response to determining that the data resources associated with the second condition recorded by the conditional data record are sufficient to complete the transfer request.

20. A non-transitory computer-readable storage medium comprising processor-executable instructions which, when executed, configure a processor to:
receive a first transfer of first data resources to an account, the first transfer having a first condition restricting use of the first data resources;
update a conditional data record based on the first data resources, the conditional data record recording only data resources associated with conditions restricting use, the conditional data record excluding data resources defined in a non-conditional data record that records data resources having no conditions restricting use;
receive a transfer request for second data resources, the transfer request including metadata defining a second condition;
based on the metadata, determine whether data resources associated with the conditional data record or data resources associated with the non-conditional data record should be used to complete the transfer request; and
complete the transfer request.
